(19) United States
(12) Patent Application Publication
(10) Pub. No.: US 2011/0250305 A1
(43) Pub. Date: Oct. 13, 2011

(54) MOLD DEVICE

(76) Inventors: Yang Ho Moon, Gyunggi-do (KR); In Lee, Gyunggi-do (KR)

(21) Appl. No.: 12/789,380

(22) Filed: May 27, 2010

(30) Foreign Application Priority Data
Apr. 8, 2010 (KR) 10-2010-0032401

(51) Int. Cl. B28B 7/10

(52) U.S. Cl. 425/3

(57) ABSTRACT

Disclosed herein is a mold device. The mold device includes: an injection molding core; an ejector pin disposed under the core to pull the core in injection; a first magnet disposed at the lower end of the core; and a second magnet disposed at the upper end of the ejector pin to attract the first magnet and prevent the core from being biased.

### CROSS REFERENCE TO RELATED APPLICATION

This application claims the benefit of Korean Patent Application No. 10-2010-0032401, filed on Apr. 8, 2010, entitled “A Mold Device”, which is hereby incorporated by reference in its entirety into this application.

### BACKGROUND OF THE INVENTION

1. Technical Field

The present invention relates to a mold device.

2. Description of the Related Art

The present invention relates to a mold device, in particular, to a lens mold device. Plastic lenses have the advantage in low material cost and high productivity in comparison with glass lenses, such that they are used for various fields, such as mobile phone cameras and disc pick-up devices. The picture performance of camera modules of mobile and the form accuracy of lenses are in close connection with each other and the outer diameter of the lenses and concentricity of a non-spherical curved surface are one of the factors having the most relation to the picture performance. The lenses of the camera modules of mobile phones are made of plastic lenses and glass lenses and the plastic lenses are manufactured by injection molding. Since the lens-shaped portion of the mold is transcribed to form the shape of a lens product in the injection molding, the accuracy of the mold is very important and the concentricity of the portion corresponding to the outer diameter of the lens product and the portion corresponding to the non-spherical surface of the lens in the mold has a direct effect on the concentricity of the lens product.

FIG. 7 is a cross-sectional view showing the entire structure of a molding for forming an injection-molded part of a lens according to the related art, in which the molding includes a movable plate 11, a movable core 12, a stationary plate 13, and a stationary core 14. As shown in the figure, the concentricity of the lenses are affected by the driving accuracy of the movable core 12, machining accuracy of the lens outer circumference of the movable plate 11, an assembly gap of the movable core 12 and the movable plate 11, machining accuracy of the stationary core 14, an assembly gap of the stationary core 14 and the stationary plate 13, and shape accuracy of the movable plate 11 and the stationary plate 15.

In the lens mold device according to the related art, an ejector pin is fastened by a core and a bolt to eject the movable core after filling the lens gap. However, in this configuration, when the concentricity of the ejector pin and the core is not matched, the core biases in fastening the ejector pin with the bolt, such that it may fail to achieve accurate concentricity of the injection-molded part for the lens.

Therefore, research for removing the problems and improving the concentricity in a lens mold is significantly required.

### SUMMARY OF THE INVENTION

The present invention has been made in an effort to provide a mold device having improved concentricity of the mold, removing the problems.

A mold device according to an exemplary embodiment of the present invention includes: an injection molding core; an ejector pin disposed under the core to pull the core in injection; a first magnet disposed at the lower end of the core; and a second magnet disposed at the upper end of the ejector pin to attract the first magnet and prevent the core from being biased.

In this configuration, the first magnet and the second magnet are fastened to the core and the ejector pin by a first fastening member and a second fastening member, respectively.

Further, the first fastening member and the second fastening member are bolts or pins.

Further, a plate is further provided under the ejector pin, and a first magnet and a fourth magnet are further disposed at the lower end of the ejector pin and the upper end of the plate.

Further, the core ejects a lens mold.

A mold device according to another exemplary embodiment of the present invention includes: an injection molding core; an ejector pin fastened to the core; a plate disposed under the ejector pin to support the ejector pin; a third magnet disposed at the lower end of the ejector pin; and a fourth magnet disposed at the upper end of the plate to attract the third magnet.

In this configuration, the third magnet and the fourth magnet are fastened to the ejector pin and the plate by a third fastening member and a fourth fastening member, respectively.

Further, the third fastening member and the fourth fastening member are bolts or pins.

Further, the core ejects a lens mold.

A mold device according to another exemplary embodiment of the present invention includes: an injection molding core; a metal-based ejector pin fastened to the core; a plate disposed under the ejector pin to support the ejector pin; and a fourth magnet disposed at the upper end of the plate to attract the ejector pin.

In this configuration, the fourth magnet is fastened to the plate by a fourth fastening member.

Further, the fourth fastening member is a bolt or a pin.

Further, the core ejects a lens mold.

### BRIEF DESCRIPTION OF THE DRAWINGS

FIG. 1 is a cross-sectional view of a mold device according to a first exemplary embodiment of the present invention;

FIG. 2 is a cross-sectional view of a mold device according to a second exemplary embodiment of the present invention;

FIG. 3 is a cross-sectional view of a mold device according to a third exemplary embodiment of the present invention;

FIG. 4 is a cross-sectional view of a mold device according to a fourth exemplary embodiment of the present invention;

FIG. 5 is a partial enlarged view of a mold device according to exemplary embodiments of the present invention;

FIG. 6 is a perspective view of a lens shape according to exemplary embodiments of the present invention; and

FIG. 7 is a cross-sectional view showing the entire structure of a molding according to the related art.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the gist of the present invention.

Hereinafter, exemplary embodiments of the present invention will be described in detail with reference to the accompanying drawings.

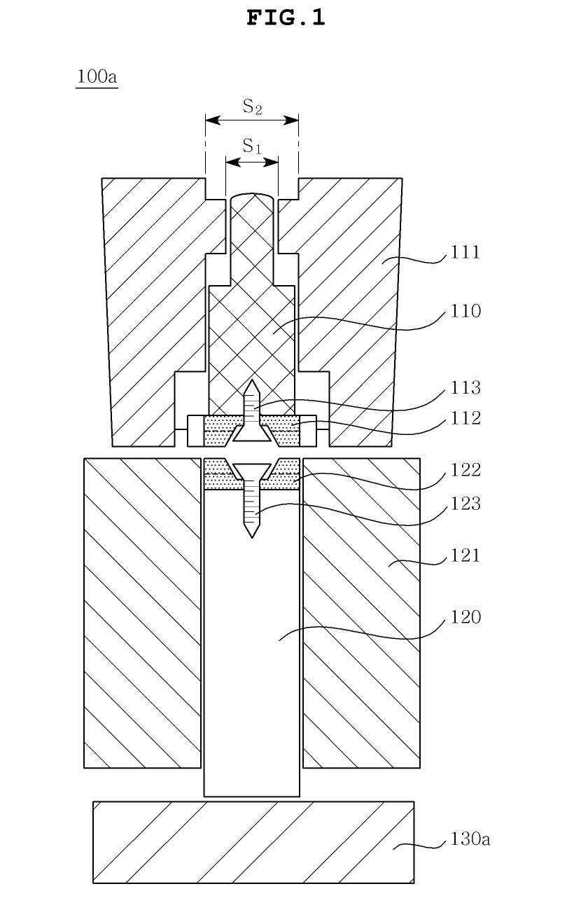

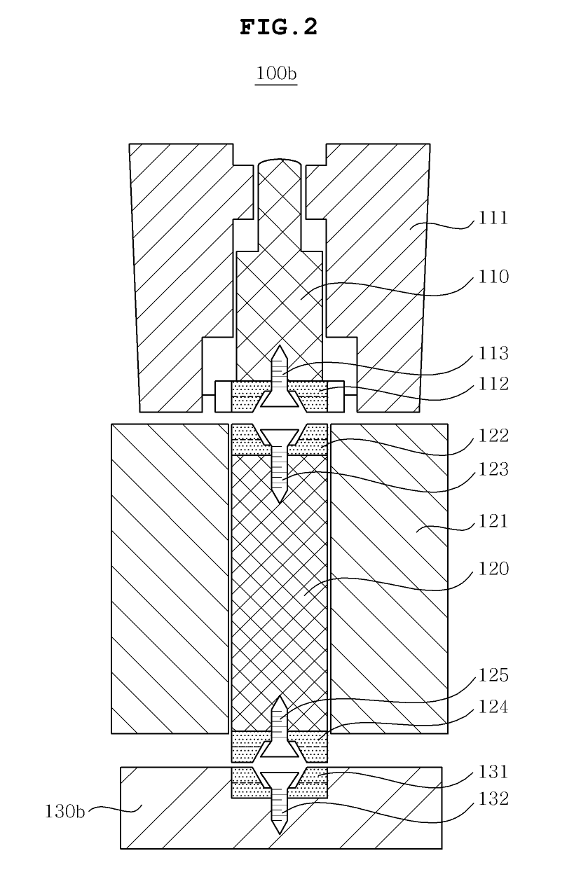

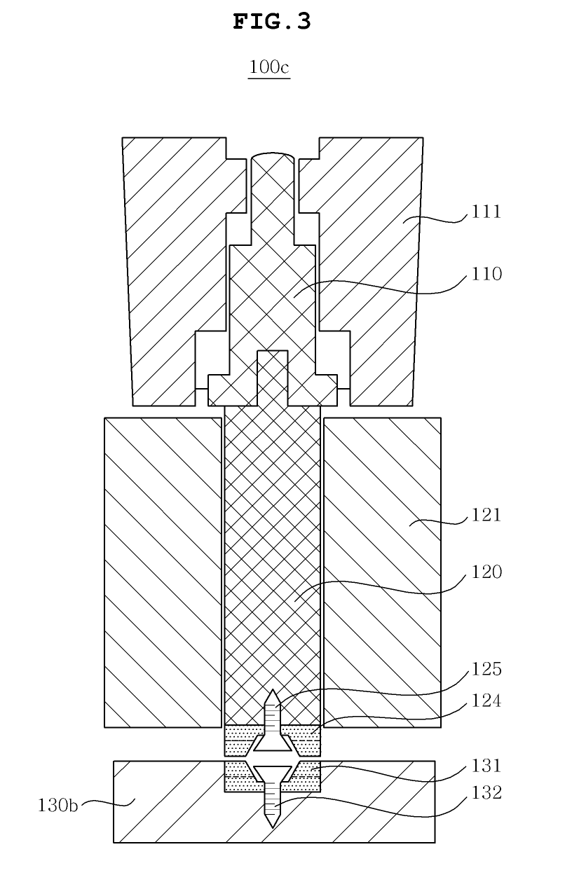

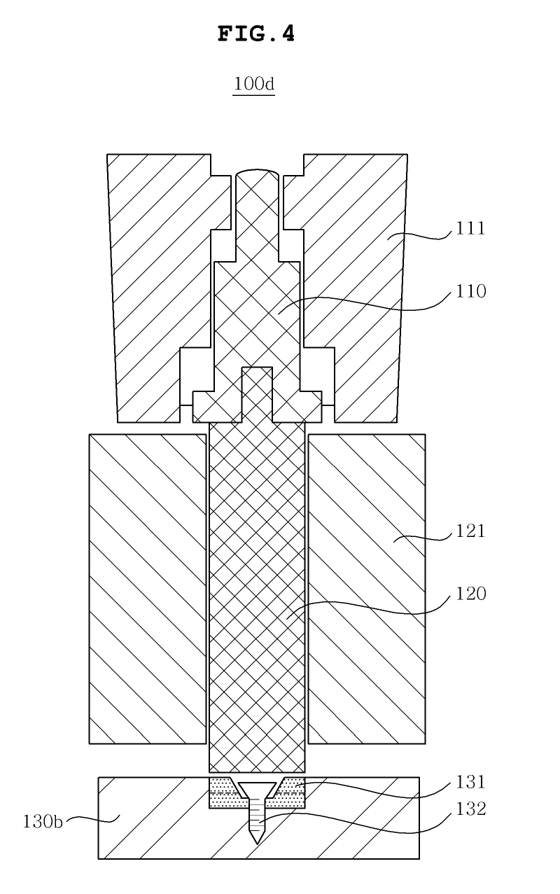

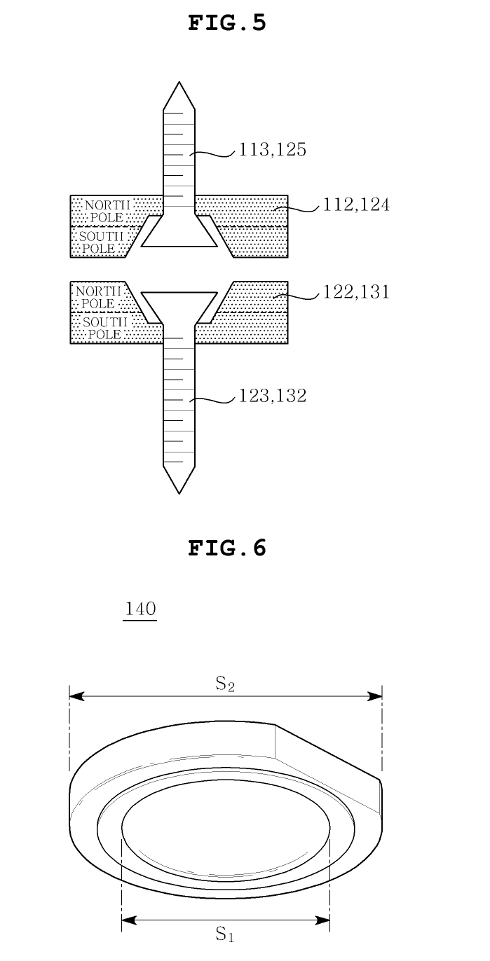

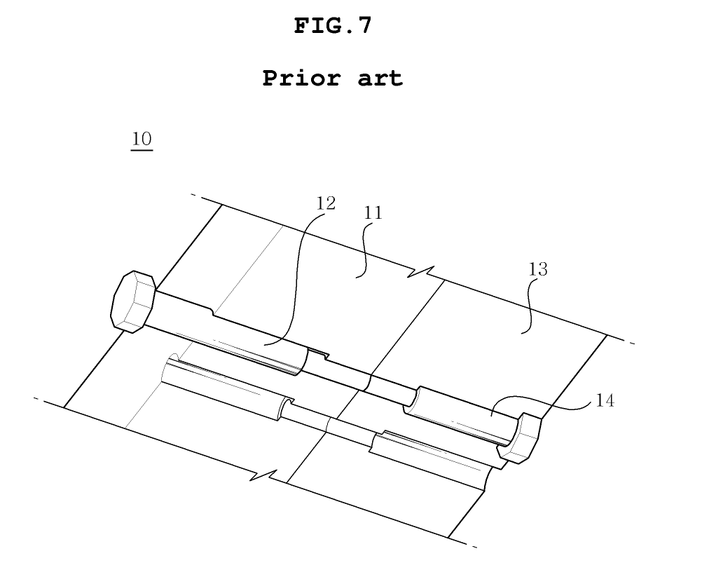

FIG. 1 is a cross-sectional view of a mold device according to a first exemplary embodiment of the present invention, FIG. 2 is a cross-sectional view of a mold device according to a second exemplary embodiment of the present invention, and FIG. 3 is a cross-sectional view of a mold device according to a first exemplary embodiment of the present invention. Further, FIG. 4 is a cross-sectional view of a mold device according to a fourth exemplary embodiment of the present invention, FIG. 5 is a partial enlarged view of a mold device according to exemplary embodiments of the present invention, and FIG. 6 is a perspective view of a lens shape according to exemplary embodiments of the present invention.

As shown in FIG. 1, a mold device 100a according to a first exemplary embodiment of the present invention includes a core 110, a first platen 111, a first magnet 112, a first fastening member 113, an ejector pin 120, a second platen 121, a second magnet 122, a second fastening member 123, and a plate 130.

The core 110 is disposed inside the first platen 111 shaping a mold and used to eject the mold.

S1 of the first platen 111 represents the curved surface of a plastic lens that is a mold according to an exemplary embodiment of the present invention and S2 represents the outer diameter of the plastic lens.

Concentricity of the plastic lens is associated with optical properties of a camera and the magnitude becomes more restricted with the increase in pixels of the camera. Therefore, the value of the center of the concentricity to the center of the outer diameter is considered important.

The first magnet 112 is attached to the lower end of the core 110 and the core 110 and the first magnet 112 are combined by the first fastening member 113.

The ejector pin 120 separates the product from the mold, as the mold opens, and is fixed by the second platen 121.

A second magnet 122 is attached to the upper end of the ejector pin 120, at the position corresponding to the first magnet 112 attached to the lower end of the core 110. The second magnet 122 and the first magnet 112 attract each other such that the ejector pin 120 and the core 110 are positioned adjacent to each other. The second magnet 122 and the ejector pin 120 are combined by the second fastening member 123.

In this configuration, although the first fastening member 113 and the second fastening member 123 can be variously implemented by bolts, pins, and adhesives, etc., it should be noted that they are included in the spirit of the present invention.

When the lower end of the core 110 is attached to the upper end of the ejector pin 120 by the magnets, the core 110 is not biased even if concentricity is not achieved between the core 110 and the ejector pin 120 in ejecting the product. In this configuration, the polarities of first magnet 112 and the second magnet 122 are arranged such that the magnets attract each other, as shown in FIG. 5.

Since the temperature of the mold is around 150° C. in injecting the lens, the magnets should be made of a heat resistance material (e.g. neodymium magnet) keeping magnetism even at the temperature. Further, the core 110 is not biased nor deformed to one side in assembling even if the centers of the ejector pin hole and the core holes do not match. Since the core 110 is attracted by the magnet even in this state, it does not matter in ejecting the product.

The plate 130 supports the lower end of the ejector pin 120 to easily eject the core 110.

FIG. 2 shows a mold device 100b according to a second exemplary embodiment of the present invention and of which the basic configuration and shape are the same as those of the mold device 100a according to the first exemplary embodiment of the present invention; therefore, the function and characteristics of the same parts are not described.

Although the mold device 100b according to a exemplary second embodiment of the present invention is basically the same as the structure and the shape of the mold device 100a according to the first embodiment, it is different in that a third magnet 124 is attached to the lower end of the ejector pin 120. The ejector pin 120 and the third magnet 124 are combined by a third fastening member 125.

A fourth magnet 131 is attached to the upper surface facing the third magnet 124 of the plate 130b. The polarities of the third magnet 124 and the fourth magnet 131 are arranged such that the magnets attract each other. The plate 130b and the fourth magnet 131 are combined by the fourth fastening member 132.

In this configuration, although the third fastening member 125 and the fourth fastening member 132 can be variously implemented by bolts, pins, and adhesives, etc., it should be noted that they are included in the spirit of the present invention.

FIG. 3 shows a mold device 100c according to a third exemplary embodiment of the present invention and of which the basic configuration and shape are the same as those of the mold device 100a according to the first exemplary embodiment of the present invention; therefore, the function and characteristics of the same parts are not described.

Although the mold device 100c according to the third exemplary embodiment of the present invention is basically the same as the structure and the shape of the mold device 100a according to the first embodiment, it is different in that the core 110 and the ejector pin 120 are combined by a bolt (not shown) as in the related art, and the third magnet 124 and the fourth magnet 131 are disposed at the lower end of the ejector pin 120 and the upper end of the plate 130b, respectively.

The polarities of the third magnet 124 and the fourth magnet 131 are arranged such that the magnets attract each other, and the magnets are fastened by the third fastening member 125 and the fourth fastening member 132, respectively.

The plate 130b and the ejector pin 120 are attached by the third magnet 124 and the fourth magnet 131.

FIG. 4 shows a mold device 100d according to a fourth exemplary embodiment of the present invention and of which the basic configuration and shape are the same as those of the mold device 100a according to the first exemplary embodiment of the present invention; therefore, the function and characteristics of the same parts are not described.

Although the mold device 100d according to the fourth exemplary embodiment of the present invention is basically the same as the structure and the shape of the mold device 100a according to the first embodiment, it is different in that the core 110 and the ejector pin 120 are combined by a bolt (not shown) as in the related art, and the fourth magnet 131 is disposed only at the upper end of the plate 130 where the lower end of the ejector pin 120 contacts.

The ejector pin 120 is made of a metal-based material, such that it can be attached to the fourth magnet 131 of the plate 130b, without being provided with a specific magnet. The core 110 is ejected by the ejector pin 120 and the plate 130b attached to each other.

FIG. 5 shows when different polarities are disposed to face each other such that attracting force is generated between the first and third magnets 112 and 124 and the second and fourth magnets 122 and 131 included in the mold devices 100a, 100b, 100c, and 100d according to the embodiments of the present invention. The first and third magnets 112 and 124 and the second and fourth magnets 122 and 131 are respectively combined by the first and third bolts 113 and 125 and the second and fourth bolts 123 and 132.

FIG. 6 shows a lens 140 injection-molded by the mold devices 100a, 100b, 100c, and 100d according to the exemplary embodiments of the present invention, in which S1 represents the curved surface of the lens and S2 represents the outer diameter of the lens. In this configuration, the concentricity of the center of the curved surface to the center of the outer diameter is an important factor in the performance of a camera, it can be seen from an experiment that the concentricity of the lens 140 injection-molded by the mold devices 100a, 100b, 100c, and 100d according to the embodiments of the present invention is 2˜5 μm, which is considerably improved, in comparison to 9˜13 μm in the related art.

In the mold devices 100a, 100b, 100c, and 100d according to the present invention, it is possible to easily improve the concentricity of an injection-molded product by disposing a magnet between the core 110 and the ejector pin 120 or between the ejector pin 120 and the plate 130 to attach them.

In particular, it is also very effective in adjusting the concentricity of the plastic lens products.

According to a mold device of the present invention, it is possible to easily improve concentricity of an injection-molded product by disposing a magnet between a core and an ejector pin or the ejector pin and a plate to attach them, such that it is very effective particularly in adjusting the concentricity of plastic lens products.

Although the embodiments of the present invention has been disclosed for illustrative purposes, it will be appreciated that a mold device according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A mold device comprising:
an injection molding core;
an ejector pin disposed under the core to pull the core in injection;
a first magnet disposed at the lower end of the core; and
a second magnet disposed at the upper end of the ejector pin to attract the first magnet and prevent the core from being biased.

2. The mold device as set forth in claim 1, wherein the first magnet and the second magnet are fastened to the core and the ejector pin by a first fastening member and a second fastening member, respectively.

3. The mold device as set forth in claim 2, wherein the first fastening member and the second fastening member are bolts or pins.

4. The mold device as set forth in claim 1, wherein a plate is further provided under the ejector pin, and a first magnet and a fourth magnet are further disposed at the lower end of the ejector pin and the upper end of the plate.

5. The mold device as set forth in claim 1, wherein the core ejects a lens mold.

6. A mold device comprising:
an injection molding core;
an ejector pin fastened to the core;
a plate disposed under the ejector pin to support ejector pin;
a third magnet disposed at the lower end of the ejector pin; and
a fourth magnet disposed at the upper end of the plate to attract the third magnet.

7. The mold device as set forth in claim 6, wherein the third magnet and the fourth magnet are fastened to the ejector pin and the plate by a third fastening member and a fourth fastening member, respectively.

8. The mold device as set forth in claim 7, wherein the third fastening member and the fourth fastening member are bolts or pins.

9. The mold device as set forth in claim 7, wherein the core ejects a lens mold.

10. A mold device comprising:
an injection molding core;
a metal-based ejector pin fastened to the core;
a plate disposed under the ejector pin to support the ejector pin; and
a fourth magnet disposed at the upper end of the plate to attract the ejector pin.

11. The mold device as set forth in claim 10, wherein the fourth magnet is fastened to the plate by a fourth fastening member.

12. The mold device as set forth in claim 11, wherein the fourth fastening member is a bolt or a pin.

13. The mold device as set forth in claim 10, wherein the core ejects a lens mold.
